(19) United States
(12) Patent Application Publication
(10) Pub. No.: US 2002/0098885 A1
(43) Pub. Date: Jul. 25, 2002

(54) Video game system and control method thereof and program of video game and computer readable record medium recorded with the program

(75) Inventor: Hironobu Sakaguchi, Honolulu, HI (US)

Correspondence Address: GREENBLUM & BERNSTEIN, P.L.C., 1941 ROLAND CLARKE PLACE, RESTON, VA, 20191, US

(73) Assignee: SQUARE CO., Tokyo (JP)

(21) Appl. No.: 09/819,541

(22) Filed: Mar. 29, 2001

(30) Foreign Application Priority Data
Jan. 24, 2001 (JP) 2001-16169

(51) Int. Cl. A63F 13/00

(52) U.S. Cl. 463/31

(57) ABSTRACT

A network video game pertinently displays information of another character operated by another player without unnecessarily occupying a screen. A player computer capable of connecting to a server via a network displays the other character operated by another computer connected to the server. When a player character operated by the player computer is disposed within a predetermined distance from the other character, information about the other character is displayed near the other character. Because the information of the other character is displayed only when the player character is disposed within a predetermined distance from the other character, the screen is not always occupied by the character information.

### CROSS REFERENCE TO RELATED APPLICATION

The present disclosure relates to subject matter contained in Japanese Patent Application No. 2001-16169, filed on Jan. 24, 2001, the disclosure of which is expressly incorporated herein by reference in its entirety.

### BACKGROUND OF THE INVENTION

1. Field of the Invention

The present invention relates to a video game system and a control method thereof, video game apparatus and a control method thereof and a program of a video game and a computer readable record medium recorded with the program, particularly to a network video game in which a group of players can participate via a network.

2. Description of Related Art

In recent years, network video games in which a group of players simultaneously participate, combat, cooperate or play by utilizing a network, have increased in popularity. Such a video game is referred to as a network game or an online game.

In an online game, a group of players respectively operating a group of computers connected to a server, can make respective characters act in a common virtual space. The players can frequently combat or cooperate with each other by communicating with each other.

Generally, a player character is provided with various character information such as HP (Hit Point), MP (Magic Point) or a character level. In an online game, it is convenient to communicate when a player can acquire not only information of a character operated by the player, but also information to some degree of characters operated by other players.

However, when character information of the other player character is always displayed, a screen becomes difficult to look at. Not only can a player not efficiently browse information, but also there is a concern of hampering the game play.

### SUMMARY OF THE INVENTION

Hence, it is an object of the present invention to provide a video game system and a control method thereof pertinently displaying information of a character operated by another player without occupying too much screen space, a video game apparatus and a control method thereof, as well as a program of a video game and a computer readable record medium recorded with the program.

According to the invention, there is realized a video game in which a group of players can make respective characters act in a common virtual world. According to an aspect of the invention, a player computer capable of connecting to a server via a network, displays another character operated by another computer connected to the server via the network. The player computer displays information about the other character near the other character when a player character operated by the player computer is disposed within a predetermined distance from the other character.

According to another aspect of the invention, a player computer capable of connecting to a server via a network displays another character operated by another computer connected to the server via the network and a movable pointer. The player computer also displays information about the other character in the vicinity of the other character when the pointer is disposed within a predetermined distance from the other character in a screen.

According to the invention, the information of the other character is displayed only when the player character or the pointer is disposed within the predetermined distance from the other character. Therefore, the screen is not unnecessarily occupied with character information. The player can view the information of the other character as necessary by moving the player character or the pointer to be near the other character.

### BRIEF DESCRIPTION OF THE DRAWINGS

FIG. 1 is a block diagram showing a constitution of a video game apparatus according to an embodiment;

FIG. 2A is a plan view showing a key pad and FIG. 2B is a rear view showing the key pad.

FIG. 3 is a view showing an example of a game system utilizing a network;

FIG. 4 is a flowchart showing an exemplary procedure for controlling a game apparatus;

FIG. 5 is a view showing an example of a display screen;

FIG. 6 is a view showing an example of a display screen;

FIG. 7 is a view showing an example of a display screen;

FIG. 8 is a flowchart showing exemplary processing executed by a game apparatus and a game server; and

FIG. 9 is a view showing an example of a display screen.

### DETAILED DESCRIPTION OF THE PREFERRED EMBODIMENTS

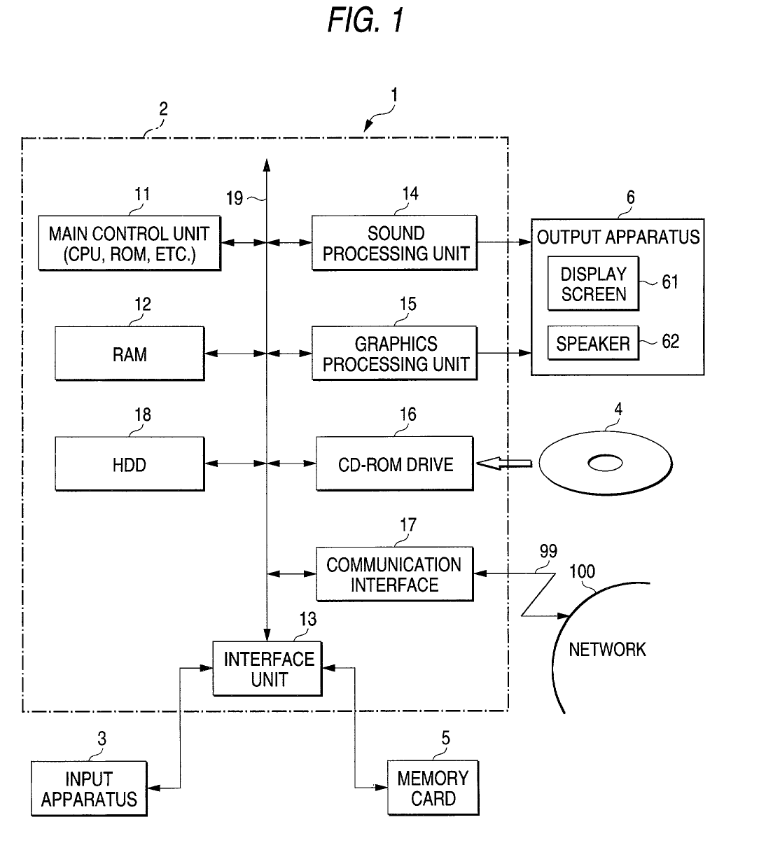

An explanation will be given of embodiments of the invention with reference to the drawings as follows. FIG. 1 is a block diagram showing a video game apparatus according to an embodiment. As an example, a video game apparatus 1 is provided with a control apparatus 2 for controlling the video game apparatus 1, an input apparatus (for example, key pad) 3 and an output apparatus (for example, television set) 6 connected to the control apparatus 2. The game apparatus 1 is further provided with a memory card 5 for preserving game data such as progress data or environment setting data of the game.

The control apparatus 2 is a computer. In this example, the control apparatus 2 is a game machine for household use. However, the control apparatus 2 is not limited thereto.

As shown by FIG. 1, the control apparatus 2 is provided with, as an example, a main control unit 11, RAM (Random Access Memory) 12, an interface unit 13, a sound processing unit 14, a graphics processing unit 15, a CD-ROM drive 16, a communication interface 17, HDD (Hard Disk Drive) 18 and a bus 19 for connecting the constituent elements to each other. Further, the CD-ROM drive 16 is constituted to be capable of attachably and detachably mounting a CD-ROM (Compact Disc Read Only Memory) 4 which is a recording medium stored with programs, image data and sound data for realizing processing with regard to a game, mentioned later.

The main control unit 11 is a circuit having a CPU (Central Processing Unit) and ROM (Read Only Memory) and the CPU controls respective portions of the control apparatus 2 in accordance with programs stored to RAM 12 (or ROM depending on cases). The ROM is stored with basic programs such as a boot program or OS (Operating System) of the control apparatus 2. Further, the main control unit 11 is provided with an oscillator and a timer counter (both not illustrated) for generating a clock signal based on a timing signal output at each predetermined period from the oscillator and time is measured by counting the clock signal by the timer counter.

RAM 12 is a main storage unit which the CPU of the main control unit 11 uses for executing programs and is stored with programs executed by the CPU and data necessary for the execution. RAM 12 is used also as a work area in executing programs.

The interface unit 13 is constituted to be capable of attachably and detachably connecting the input apparatus 3 and the memory card 5. The interface unit 13 controls data transmission between respective portions connected to the bus 19 (mainly, main control unit 11) and the input apparatus 3 or the memory card 5.

The sound processing unit 14 is a circuit for carrying out a processing for reproducing vocal data such as BGM (Back Ground Music) or a sound effect of game. The sound processing unit 14 generates a vocal signal based on data stored to RAM 12 and supplies the vocal signal to the output apparatus 6 in accordance with instruction from the main control unit 11.

The graphics processing unit 15 is provided with a frame buffer (not illustrated) and draws an image in accordance with the instruction from the main control unit 11 on the frame buffer. Further, the graphics processing unit 15 generates a video signal by adding a predetermined synchronizing signal to image data drawn to the frame buffer and supplies the video signal to the output apparatus 6.

The CD-ROM drive 16 is a reading apparatus for reading data stored to CD-ROM 4 which is a recording medium. The game apparatus 1 realizes control with regard to the game, mentioned later, by making the control apparatus 2 execute control in accordance with a game program recorded to CD-ROM 4.

The communication interface 17 is a circuit for carrying out communication control in exchanging various data with other apparatus on a network 100 and is connected to the network 100 via a communication line 99 as necessary. The communication interface 17 controls transmission and reception of information (program or data) between the control apparatus 2 and the communication network 100. Game program or data downloaded from the outside communication network 100 via the communication interface 17 and the communication line 99, can be stored to HDD 18.

HDD 18 is an auxiliary storage unit which the CPU of the main control unit 11 uses for executing programs. HDD 18 can be stored with various data or programs such as information downloaded by using the communication interface 17 or information read from CD-ROM 4.

CD-ROM 4 is stored with game software. The game software includes game programs and necessary data for making the main control unit execute processing necessary for executing the computer game. The game program includes programs for making the game apparatus 1 execute a method according to the embodiment. The game software stored to CD-ROM 4 can be read by operating the CD-ROM drive 16.

Further, the game apparatus 1 can store the game software also at HDD 18. The game software may be preinstalled to HDD 18 or can also be installed from CD-ROM 4 or downloaded from another apparatus on the communication network 100, as mentioned above.

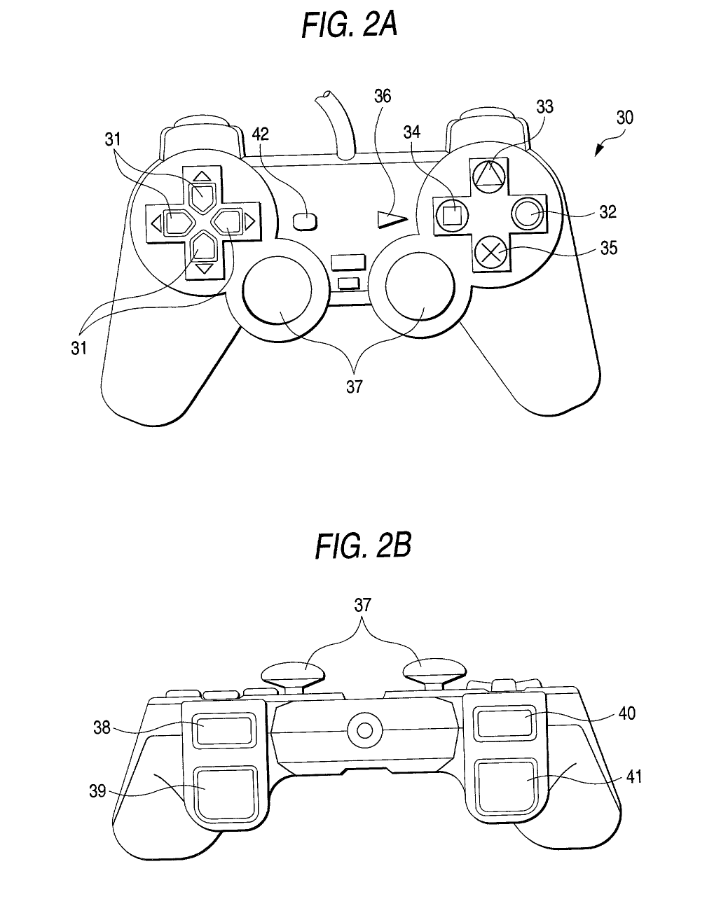

The input apparatus 3 is provided with a group of operation tools operated by the player for inputting various instructions with regard to the game to the control apparatus 2. When the operation tool is operated, the input apparatus 3 transmits an instruction signal in accordance with the operation tool to the control apparatus 2 via the interface unit 13. According to the embodiment, as an example, there is prepared a key pad 30 (FIG. 2A) generally attached to the game machine for household use as the input apparatus 3.

FIG. 2A is a plan view showing the key pad 30 and FIG. 2B is a rear view showing the key pad 30. The key pad 30 is provided with a cross key 31 for inputting direction instructions and operation keys for inputting various instructions to the control apparatus 2 (for example, ∘ button 32, Δ button 33, □ button 34, × button 35, start button 36, select button 42) as operation tools as shown in FIG. 2A. Further, the key pad 30 is also provided with joy sticks 37 as operation tools. As shown by FIG. 2B, a rear face of the key pad is provided with various operation keys (R1 button 38, R2 button 39, L1 button 40, L2 button 41) as operation tools. Further, the key pad 30 is provided with a vibration function. That is, the key pad 30 is built with a motor. The motor is operated by receiving a predetermined control signal from the control apparatus 2 and the whole key pad 30 can be vibrated.

The memory card 5 is an auxiliary storage apparatus constituted by a flash memory for storing game data by being controlled by the control apparatus 2. The main control unit 11 controls to write data to the memory card 5 and read data from the memory card 5 via the interface unit 13.

The output apparatus 6 displays a game image and outputs voice based on an image signal and the vocal signal from the control apparatus 2. According to the embodiment, there is prepared a television (TV) set as the output apparatus 6. The television set is provided with a display screen 61 for displaying images and a speaker 62 for outputting voice. The television set displays an image on the display screen 61 in response to a video signal from the graphics processing unit 15 and outputs voice from the speaker 62 in response to a sound signal from the sound processing unit 14. Therefore, the television set functions both as a display apparatus and a voice output apparatus.

The main control unit 11 controls operation of the control apparatus 2 based on basic software stored to ROM and game software stored to RAM 12 read from CD-ROM 4 by the CD-ROM drive 16. For example, the main control unit 11 reads graphics data from CD-ROM 4 and transmits the graphics data to the graphics processing unit 15 and instructs the graphics processing unit 15 to generate an image. In response to the instruction, the graphics processing unit 15 generates the video signal by utilizing the graphics data. The video signal is transmitted to the output apparatus 6. Thereby, the image is displayed on the display screen of the output apparatus 6.

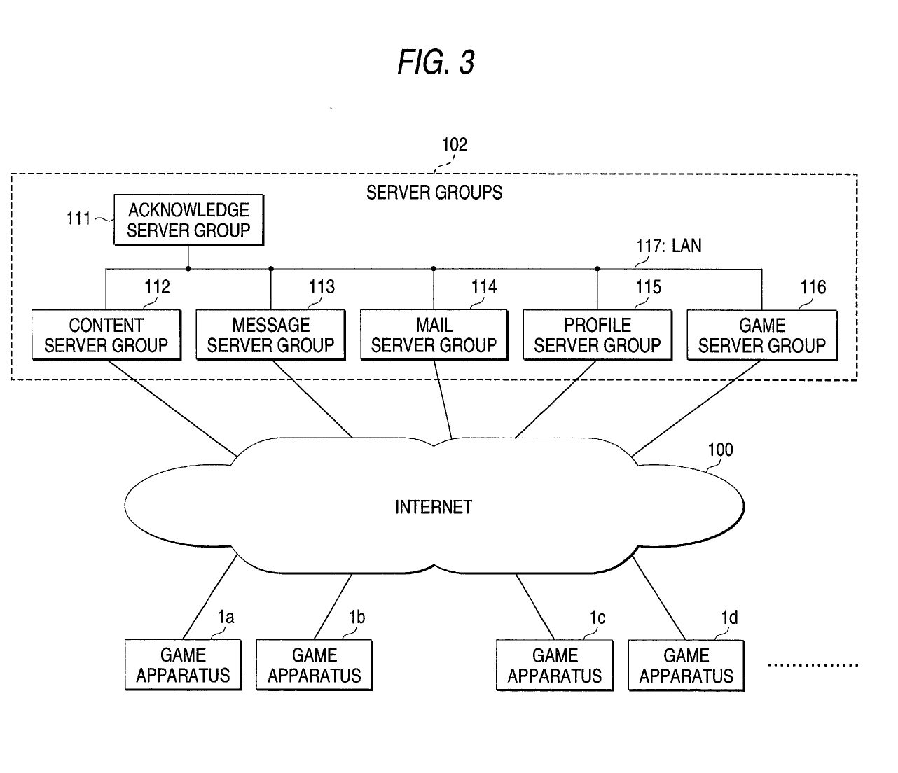

According to the embodiment, there is displayed a video game in which a number of players can participate via the network, on the screen 61 of the display apparatus 6. FIG. 3 is an outline view showing a constitution of an online game system for providing a network video game service. According to the system, video game apparatuses 1a, 2b, 1c, 1d having a constitution shown by FIG. 1 are connected to server groups 102 via the Internet 100. That is, individuals of the video game apparatus 1 are connected to any server in the server groups 102 and become clients of the server.

The server groups 102 include an acknowledgement server group 111 for carrying out an account control for acknowledging users, a content server group 112 for providing an interface between the game apparatus 1 and the other server groups and providing a service of browsing content such as voice and dynamic images, a message server group 113 for providing an environment of chat or messenger, a mail server group 114 for providing a service of electronic mail, a profile server group 115 for controlling profiles of users and a game server group 116 for providing a game environment. These server groups 111 through 116 are connected to each other via LAN 117.

The game server group 116 includes a server connected with multiple game apparatuses 1 enabling a player to search for a play mate. The server provides a virtual lobby for gathering players and making communication and therefore, the server may be referred to as a lobby server. When the game apparatus 1 is connected to the lobby server, a screen representing a virtual “lobby” is displayed on the display apparatus 6. The lobby screen is displayed with a player character of its own and characters of other players connected to the lobby server. The player can have a chat, thereby, the player can communicate with other players and search for a play mate for playing a game with. When “start of game” is selected from a menu displayed on the lobby screen, the game apparatus 1 is connected to a game server in the game server group 116, a game screen is displayed on the display apparatus 6 and the game is started. The game screen is displayed with a player character of its own and, in addition thereto, when there is present another player participating in the game, a character of the other player is also displayed.

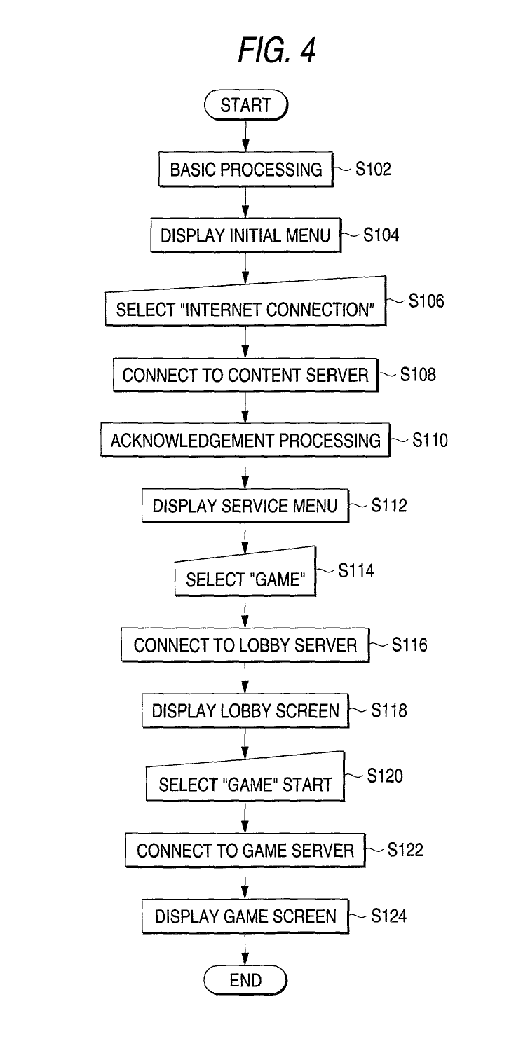

FIG. 4 is a flowchart showing a log-in processing for connecting the game apparatus 1 to the game server. First, by setting CD-ROM 4 recorded with a game program to the control apparatus 2, there is carried out a basic processing including display of an initial screen (maker logotype or the like), check of the memory card 5, display of a title screen and loading of data (step S102).

Next, an initial menu is displayed on the display apparatus 6 (step S104). When the player selects “Internet connection” (step S106), the game apparatus 1 is connected to one server in the content server group 112 via the Internet 100 (step S108).

Next, a procedure of acknowledging the player is executed (step S110). When the game apparatus 1 is connected to the content server, an acknowledgement request screen is displayed on the display apparatus 6. The player inputs information necessary for acknowledgement in the displayed acknowledgement request screen. The input information is transmitted from the game apparatus 1 to the acknowledgement server group 11 via the content server and acknowledgement is carried out at the acknowledgment server group 111.

When the acknowledgement is acquired, a service menu is displayed on the display apparatus 6 (step S112). When the player selects “game” from titles of services displayed on the service menu (step S114), the game apparatus 1 is connected to the lobby server included in the game server group 116 (step S116), and the lobby screen is displayed on the display apparatus 6 (step S118). When “start of game” is selected from the menu displayed on the lobby screen (step S120), the game apparatus 1 is connected to one game server in the game server group 116(step S122) and a game screen is displayed on the display apparatus 6 (step S124). Thereby, the game is started.

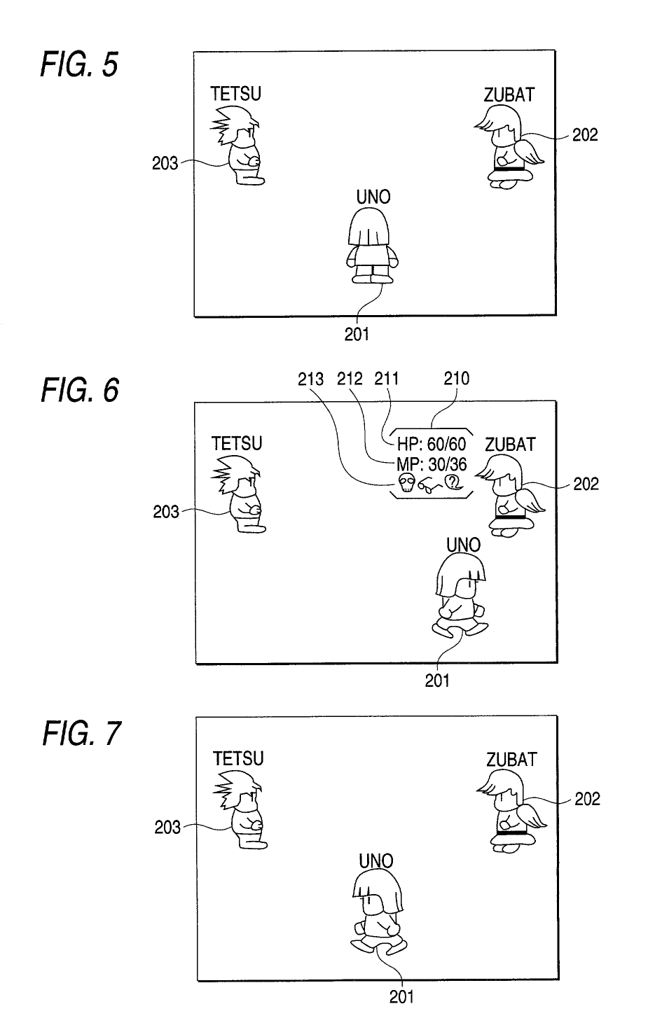

According to the video game of the embodiment, a virtual world is displayed on the display apparatus 6 when the game apparatus 1 communicates with the game server. FIG. 5 shows an example of the game screen displayed on the screen 61 of the display apparatus 6 for representing the virtual world. The video game according to the embodiment is an online RPG and there can simultaneously be present characters 201 through 203 of players respectively operating the group of game apparatuses 1a, 1b, 1c, 1d connected to the common game server. The player can make the player character act in the virtual world by inputting instructions to the game apparatus 1 by operating the input apparatus 3.

The player can move the player character in the virtual world by operating the cross key 31 or the joy sticks 37 of the key pad 30. For example, when the player inputs information of moving the player character 201 to the game apparatus 1 via the key pad 30, the game apparatus 1 moves the player character 201 on the screen 61 of the display apparatus 6 by using the information of moving thereof and transmits the information of thereof to the game server. The game server updates position data of the player character 201 stored to a storage unit by using the information of movement thereof. The position data is transferred to the game apparatus operated by another player as necessary and is reflected to display on a display apparatus connected to the game apparatus. Further, the position data of the player character 201 is stored also to RAM 12 of the game apparatus 1 for operating the player character 201. The characteristic of the video game according to the embodiment resides in that when the player character is disposed within a predetermined distance from the character of another player (hereinafter, referred to as “other character”), predetermined character information (for example, HP, MP and status abnormality) is automatically displayed.

FIG. 6 shows an example of a game screen displayed on the display apparatus 6 connected to the game apparatus 1 of the player operating the player character 201, and shows a system for displaying character information of the other character 202. As shown by FIG. 6, when the player character 201 approaches the other character 202 by moving the player character 201 by the player, information with regard to the other character 202 is displayed at a character information display area 210 arranged in the vicinity of the other character 202. According to the embodiment, the character information display area 210 includes an HP display line 211 indicating current HP (Hit Point) of the character 202, an MP display line 212 indicating current MP (Magic Point) of the character 202 and a status abnormality display line 213 for displaying one or more icons indicating current status abnormality of the character 202. The character information is displayed to accompany the other character 202 and when the other character 202 is moved, display of the character information is moved to maintain a positional relationship with the other character.

FIG. 7 shows a display screen when the player character 201 is moved to separate from the other character 202. As shown by FIG. 7, when the player character 201 becomes remote from the other character 202 by exceeding a constant distance, display of the character information is erased.

Display and erasure of the character information is caused not only by moving the player character but also caused by moving the other character. That is, according to the embodiment, regardless of whether the player character is moved or the other character is moved, when the player character and the other character are disposed within the predetermined distance therebetween, the character information is displayed near the other character. Further, regardless of whether the player character is moved or the other character is moved, when the player character and the other character are separated from each other by exceeding the predetermined distance, the information of the other character, which has been displayed, is erased.

An explanation will be given of a control procedure of the video game apparatus 1 for realizing the above-described characteristic of the embodiment as follows. Further, although a game program and necessary data are read from CD-ROM 4 in accordance with a situation of progressing the processing and transferred to RAM 12, in the following explanation, a detailed explanation of reading thereof from CD-ROM 4 or transferring thereof to RAM 12 may be omitted.

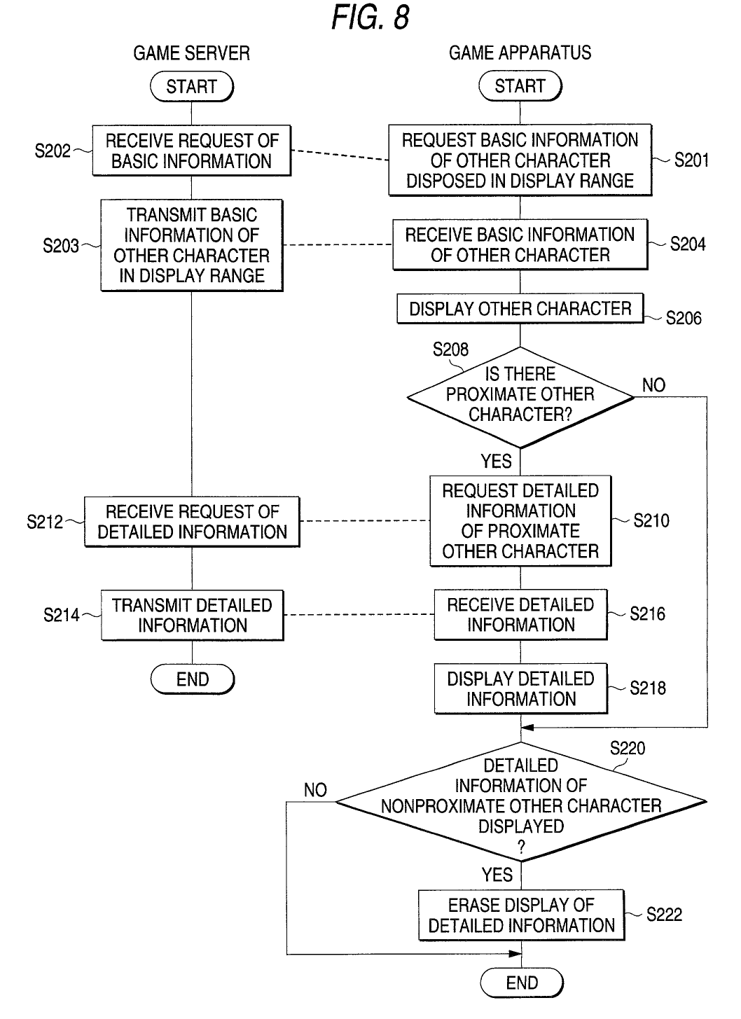

FIG. 8 is a flowchart showing the game apparatus 1 and processings executed by the game server connected with the game apparatus 1. The processings are carried out by executing the game program stored to CD-ROM 4 by the control apparatus 2 of the game apparatus 1 and executing a program exclusive for the game server.

The game apparatus 1 requests basic information with regard to the other character to be displayed on the screen 61 of the display apparatus 6 to the game server (step S201). According to the embodiment, the request is periodically carried out and accordingly, the following processing is executed also periodically. When the game server receives the request (step S202), the basic information of the other character disposed in a display range of the game apparatus 1 in the virtual world provided by the game server, is transmitted to the game apparatus 1 (step S203). The basic information is information necessary for displaying the other character and includes title data of the other character, position data of the other character and display designation data for designating a display element necessary for displaying the other character in display elements stored to CD-ROM 4.

When the game apparatus 1 receives the basic information (step S204), the game apparatus 1 displays the other character by using the basic information and the display element stored to CD-ROM 4 and displays the player character by using basic information of the player character stored to RAM 12 and a display element stored to CD-ROM 4 (step S206). In this way, as shown by FIG. 5, the player character 201 as well as other characters 202 and 203 are displayed on the screen 61 of the display apparatus 6. Next, the game apparatus 1 determines whether there is present another character disposed within a predetermined threshold distance from the player character (step S208). That is, at step S208, it is determined whether there is present another character displayed on the screen which is particularly proximate to the player character. The determination is carried out by using position data of the player character and the other character stored to RAM 12.

When it is determined that the other character is present within a predetermined distance from the player character (step S208: YES route), the game apparatus 1 requests detailed information of the other character (step S210). The detailed information is constituted by, for example, HP, MP and status abnormality of the other character as mentioned above.

When the game server receives request of detailed information of the other character from the game apparatus 1 (step S212), the game server searches the detailed information of the other character from a storage unit and transmits the detailed information to the game apparatus 1 (step S214). When the game apparatus 1 receives the detailed information (step S216), the detailed information is displayed near the other character (step S218). Specifically, as shown by FIG. 6, when there are IP and MP as well as status abnormality at the character information display area 210 near the other character 202, there is displayed an icon indicating the status abnormality.

After finishing display of the detailed information, or when it is determined that there is not present another character disposed within a predetermined threshold distance from the player character at the step S208, the game apparatus 1 determines whether detailed information is displayed with regard to nonproximate other character remote from the player character by exceeding the threshold distance (step S220). When it is determined that the detailed information is displayed with regard to the nonproximate other character (step S220: YES route), the game apparatus 1 erases display of the detailed information. In this way, as shown by FIG. 7, when the other character 202 which has been proximate to the player character 201, becomes nonproximate by moving the player character 201 or the other character 202, the detailed information of the other character 202 is erased from the screen.

In this way, according to the embodiment, the detailed information is displayed only with regard to proximate other characters disposed within a constant distance from the player character among the other characters displayed in the screen. Although it is conceivable to always display detailed information with regard to all of the other characters displayed on the screen, in this case, the screen becomes difficult to look at and it is difficult to grasp necessary information. In contrast thereto, according to the embodiment, by making the player character proximate to the desired other character, information with regard to the other character can be acquired while preventing the screen from becoming cluttered.

Although a specific explanation has been given of the invention based on the embodiment as mentioned above, the invention is not limited to the above-described embodiment but can be modified variously within a range without deviating from the gist of the invention. For example, the order of the steps described above can be varied.

According to the above-described embodiment, it is determined whether the player character and the other character in the virtual space constructed by the game server are disposed within the threshold distance by using the position data thereof. However, it is not necessarily needed to derive the distance between the player character and the other character from the position data in the virtual space. For example, it may be determined whether the player character and the other character are sufficiently proximate to each other by using a distance in the screen between reference points determined with regard to respective images of the player character and the other character (for example, gravitational center of image).

Further, according to the embodiment, the detailed information of the other character is displayed when the player character and the other character are near each other. However, in a video game displayed with a pointer capable of moving by the player on a screen, in place of the above-described display system or along with the above-described display system, there can be adopted a system of displaying detailed information of the other character indicated by the pointer.

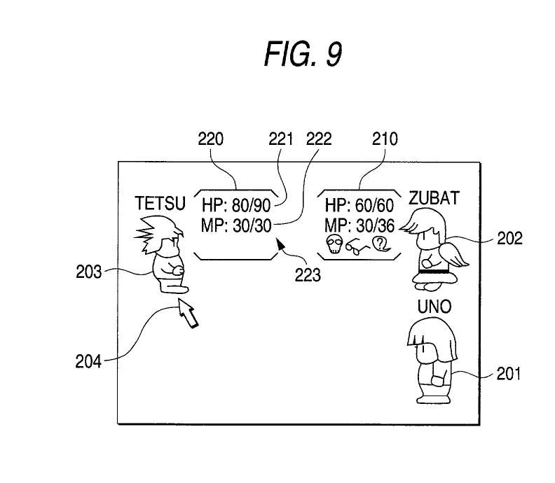

FIG. 9 shows an example of a display screen of a video game adopting such a pointer system. As shown by FIG. 9, detailed information with regard to the other character 202 near to the player character 201, is displayed in the character information display area 210. Further, with regard to the other character 203 disposed within a predetermined threshold distance from a pointer 204 in the screen, detailed information thereof is displayed in a character information display area 220. Further, a distance between the pointer 204 and the other character 203 can be defined as, for example, a distance in the screen between reference points determined with regard to respective images of the pointer 204 and the other character 203 (for example, gravitational centers). Similar to the area 210, the character information display area 220 includes an HP display line 221, an MP display line 222 and a status abnormality display line 223. When the pointer 204 and the other character are separated from each other by exceeding the threshold distance, display of the detailed information is erased. The pointer 204 can be moved by operating the input apparatus.

According to the pointer system, when the player moves the pointer to approach the other character, the detailed information of the other character can be looked at without moving the player character. This is convenient when the player does not intend to move the player character.

Further, the character information may not be displayed only by making the pointer proximate to the other character but the character information may be displayed by depressing an operation key of the input apparatus in a state in which the pointer is made proximate to the other character. Since it is necessary to depress the operation key for displaying the character information, although operation of the player is increased, it can be prevented that character information which is not intended by the player is displayed by moving the pointer.

Although according to the above-described embodiment, an explanation has been given of the invention in relation to a game machine for household use, the invention is applicable also to a general purpose computer such as a personal computer or an arcade game machine. Although according to the embodiment, the display apparatus and the input apparatus and the control apparatus are separated, the invention is applicable to a video game machine integrated with the display apparatus and the input apparatus and the control apparatus.

According to the above-described embodiment, a CD-ROM is used as a computer readable recording medium for recording the game program and data. However, the recording medium is not limited to CD-ROM but may be a computer readable other magnetic or optical record medium such as DVD (Digital Versatile Disc) or an ROM card or a semiconductor memory. Further, there may be provided a program or data for realizing the invention by a system of being previously installed to a storage unit of a game machine or a computer.

Program or data for realizing the invention may be downloaded and used from another apparatus on the network 100 connected via the communication line 99 to HDD 18 by the communication interface 17 shown in FIG. 1. Further, it is also possible that a program or data is recorded to memory of another apparatus on the communication line 99 and the program or data is successively read to RAM 12 via the communication line 99 and used as necessary.

According to a mode of providing the program or data for realizing the invention, the program or data may be provided as a computer data signal superimposed on a carrier from another apparatus on the network 100. For example, the control apparatus 2 may request transmission of a computer data signal from the communication interface 17 to the other apparatus on the communication network 100 via the communication line 99 and receive the transmitted computer data signal and store the computer data signal to RAM 12 to thereby realize the invention.

According to the invention, only when the player character or the pointer is disposed within the predetermined distance from the other character, information of the other character is displayed and therefore, the information of the other character can pertinently be displayed without unnecessarily occupying the screen.

What is claimed is:

1. A computer readable recording medium recorded with a program of a video game in which a plurality of players control respective characters in a common virtual world, the program of the video game being read by a player computer capable of connecting to a server via a network, the player computer
displaying another character operated by another computer connected to the server via the network; and
displaying information about the other character near the other character when a player character operated by the player computer is located a predetermined distance from the other character.

2. The recording medium according to claim 1:
wherein the program of the video game makes the computer further store position data of the player character;
wherein display of the other character further includes receiving position data of the other character from the server and using the position data of the other character when the position data of the other character indicates that the other character is disposed in a display range in the virtual world of the player computer; and
wherein display of the information includes display of received information by determining whether the player character is disposed within the predetermined distance from the other character by using the position data of the player character and the position data of the other character, requesting the information of the other character from the server when it is determined that the player character is disposed within the predetermined distance from the other character and receiving the information from the server.

3. The record medium according to claim 1:
wherein the program of the video game further makes the computer display the information moving along with the other character when the other character is moved, while the player character is disposed within the distance from the other character when the other character is moved.

4. The record medium according to claim 1:
wherein the program of the video game further makes the computer stop displaying the information when the player character becomes remote from the other character by exceeding the predetermined distance.

5. A video game program in which a plurality of players control respective characters in a common virtual world when said program is read by a player computer capable of connecting to a server via a network, the program making the computer:
display another character operated by another computer connected to the server via the network; and
display information about the other character near the other character when a player character operated by the player computer is disposed within a predetermined distance from the other character.

6. The video game program according to claim 5:
wherein the computer further stores position data of the player character;
wherein display of the other character further includes receiving position data of the other character from the server and using the position data of the other character when the position data of the other character indicates that the other character is within a display range in the virtual world of the player character; and
wherein display of the information further includes determining whether the player character is within the predetermined distance from the other character by using the position data of the player character and the position data of the other character, requesting the information of the other character from the server when it is determined that the player character is within the predetermined distance from the other character and receiving the information transmitted from the server.

7. The video game program according to claim 5:
wherein the computer further displays the information moving along with the other character when the other character is moved while the player character is within the predetermined distance from the other character.

8. The video game program according to claim 5:
wherein the computer further stop displaying the information when the player character becomes remote from the other character by exceeding the distance.

9. A video game system comprising:
a computer readable recording medium recorded with a program of a video game in which a plurality of players control respective characters in a common virtual world;
a first computer and a second computer respectively operated by a first player and a second player for reading the program from the recording medium and executing the program; and
a server connected with the first computer and the second computer via a network;
wherein the first computer, when the program of the video game is read by the first computer, displays another character operated by the second computer and displays information about the other character near the other character when a player character operated by the first computer is disposed within a predetermined distance from the other character.

10. A system for controlling a video game system, said video game system comprising:
a first computer;
a second computer;
a first display apparatus and a second display apparatus respectively connected to the first computer and the second computer; and
a server connected with the first computer and the second computer via a network;
wherein a video game in which a plurality of players control respective characters in a common virtual world is displayed on the first display apparatus and the second display apparatus; and
wherein the first computer displays another character operated by using the second computer on the first display apparatus, and when a player character operated by the first computer is disposed within a predetermined distance from the other character, displays information about the other character near the other character on the first display apparatus.

11. A video game apparatus comprising:
a computer readable recording medium recorded with a program of a video game in which a plurality of players control respective characters in a common virtual world;
a computer capable of connecting to a server via a network and reading the program from the recording medium and executing the program; and
a display apparatus connected to the computer;
wherein the computer, by reading the program from the recording medium, displays on the display apparatus another character operated by another computer connected to the server via the network and displays information about the other character near the other character on the display apparatus when a player character operated by the computer is disposed within a predetermined distance from the other character.

12. A method of controlling a video game apparatus comprising a player computer capable of connecting to a server via a network and a display apparatus connected to the player computer, the method comprising:
displaying on the display apparatus a video game in which a plurality of players control respective characters in a common virtual world;
displaying on the display apparatus another character operated by another computer connected to the server via the network; and
displaying on the display apparatus information about the other character near the other character when a player character operated by the player computer is disposed within a predetermined distance from the other character.

13. A computer readable recording medium recorded with a program of a video game in which a plurality of players can control respective characters in a common virtual world;
wherein a player computer displays, when the program of the video game is read by the player computer, which is capable of connecting to a server via a network, another character operated by another computer connected to the server via the network and a movable pointer, and displays information about the other character near the other character when the pointer is disposed within a predetermined distance from the other character in a screen.

14. The record medium according to claim 13:
wherein according to the program of the video game, while the pointer is disposed within the predetermined distance from the other character, when the other character is moved, the player computer displays the information moving along with the other character.

15. The recording medium according to claim 13:
wherein according to the program of the video game, when the pointer is separated from the other character by exceeding the predetermined distance, the computer erases the displayed information.

16. The recording medium according to claim 13:
wherein display of the information further includes display of the information when an operation key of an input apparatus connected to the player computer is depressed while the pointer is disposed within the predetermined distance from the other character in the screen.

17. A video game program in which a plurality of players control respective characters in a common virtual world:
wherein a player computer, when the program is read by the player computer, which is capable of connecting to a server via a network, displays another character operated by another computer connected to the server via the network and a movable pointer, and when the pointer is disposed within a predetermined distance from the other character, information about the other character is displayed near the other character.

18. The video game program according to claim 17:
wherein the player computer, while the pointer is disposed within the predetermined distance from the other character and the other character is moving, displays the information moving along with the other character.

19. The video game program according to claim 17:
wherein the computer further erases the displayed information when the pointer is separated from the other character by exceeding the predetermined distance.

20. The video game program according to claim 17:
wherein display of the information includes display of the information when an operation key of an input apparatus connected to the player computer is depressed while the pointer is disposed within the predetermined distance from the other character in the screen.

21. A video game system comprising:
a computer readable recording medium recorded with a program of a video game in which a plurality of players control respective characters in a common virtual world;
a first computer and a second computer respectively operated by a first player and a second player for reading the program from the recording medium and executing the program; and
a server connected with the first computer and the second computer via a network;
wherein when the program is read by the first computer, the program of the video game displays another character operated by the second computer and displaying a movable pointer; and
wherein the first computer displays information about the other character near the other character when the pointer is disposed within a predetermined distance from the other character in a screen.

22. A method of controlling a video game system comprising a first computer and a second computer, a first and a second display apparatus respectively connected to the first and the second computers, and a server connected with the first and the second computers via a network, the method comprising:
displaying a video game in which a plurality of players control respective characters in a common virtual world, on the first display apparatus and the second display apparatus;
displaying on the first display apparatus another character operated by the second computer and displaying a movable pointer; and
displaying on the first display apparatus information about the other character near the other character when the pointer is disposed within a predetermined distance from the other character in a screen of the first display apparatus.

23. A video game apparatus comprising:
a computer readable recording medium recorded with a program of a video game in which a plurality of players control respective characters in a common virtual world;
a player computer capable of connecting to a server via a network for reading the program from the recording medium and executing the program; and
a display apparatus connected to the player computer;
wherein the player computer, by reading the program from the recording medium, displays on the display screen another character operated by another computer connected to the server via the network and displays a movable pointer, and when the pointer is disposed within a predetermined distance from the other character in a screen of the display apparatus, displays information about the other character near the other character on the display apparatus.

24. A method of controlling a video game apparatus comprising a player computer capable of connecting to a server via a network, and a display apparatus connected to the player computer, the method comprising:
displaying on the display apparatus a video game in which a plurality of players control respective characters in a common virtual world;
displaying on the display apparatus another character operated by another computer connected to the server via the network and displaying a movable pointer; and
displaying on the display apparatus information about the other character near the other character when the pointer is disposed within a predetermined distance from the other character in a screen of the display apparatus.
